(19) United States
(12) Patent Application Publication
(10) Pub. No.: US 2017/0118295 A1
(43) Pub. Date: Apr. 27, 2017

(54) INFORMATION PROCESSING SYSTEM IN WHICH RANGE OF APPLICATION OF RF TAG CAN BE EXPANDED, METHOD OF CONTROLLING INFORMATION PROCESSING SYSTEM, SERVER, NON-TRANSITORY STORAGE MEDIUM ENCODED WITH COMPUTER READABLE PROGRAM, INFORMATION PROCESSING APPARATUS, AND METHOD OF CONTROLLING INFORMATION PROCESSING APPARATUS

(71) Applicant: NINTENDO CO., LTD., Kyoto-shi (JP)

(72) Inventors: Tomohiro YAMAMURA, Kyoto-shi (JP); Toshiharu IZUNO, Kyoto-shi (JP)

(21) Appl. No.: 15/070,130

(22) Filed: Mar. 15, 2016

(30) Foreign Application Priority Data
Oct. 21, 2015 (JP) 2015-207256

(51) Int. Cl. H04L 29/08

(52) U.S. Cl. CPC H04L 67/141; H04L 67/16

(57) ABSTRACT

An information processing system includes a server and a plurality of information processing apparatuses provided to be able to communicate with the server and another information processing apparatus through a network. Each information processing apparatus obtains information from an information storage medium by establishing contactless communication with the information storage medium. The server sets a combination of information processing apparatuses which establish mutual communication connection through the network, of the plurality of information processing apparatuses. The information processing apparatuses set by the server, of the plurality of information processing apparatuses, perform data communication processing therebetween, by using the information obtained from the information storage medium through the network.

This nonprovisional application is based on Japanese Patent Application No. 2015-207256 filed with the Japan Patent Office on Oct. 21, 2015, the entire contents of which are hereby incorporated by reference.

### FIELD

The present disclosure relates to an information processing system using contactless communication, a method of controlling an information processing system, a server, a program for a server, an information processing apparatus, and a program for an information processing apparatus.

### BACKGROUND AND SUMMARY

Various applications making use of contactless communication have recently been put into practical use. In general applications, with reading of some information from a radio frequency (RF) tag serving as a trigger, predetermined processing is performed.

In the technique above, however, information stored in an RF tag has been read and processing reflecting the read information has merely been performed.

It has been demanded to further enhance zest by expanding a range of application of an RF tag.

An information processing system according to one aspect includes a server and a plurality of information processing apparatuses provided to be able to communicate with the server and another information processing apparatus through a network. Each information processing apparatus obtains medium information from an information storage medium by establishing contactless communication with the information storage medium. The server sets a combination of information processing apparatuses which establish communication connection through the network, of the plurality of information processing apparatuses. Information processing apparatuses set by the server, of the plurality of information processing apparatuses, perform data communication processing therebetween, by using the medium information obtained from the information storage medium through the network.

In an exemplary embodiment, each information processing apparatus obtains information from the information storage medium by executing an application program and performs the data communication processing by using the information obtained from the information storage medium.

In an exemplary embodiment, each information processing apparatus includes a reading unit for reading the medium information stored in the information storage medium by establishing contactless communication with the information storage medium and a transmission unit for transmitting information associated with the medium information to the server in accordance with reading by the reading unit. The server includes a matching processing unit for setting information processing apparatuses which satisfy a prescribed condition for performing the data communication processing, based on information transmitted from each of the plurality of information processing apparatuses and a result transmission unit for transmitting connection information necessary for communication connection to the set information processing apparatuses of the plurality of information processing apparatuses. Each information processing apparatus further includes a communication processing unit for performing the data communication processing for transmitting and receiving data by using the medium information, based on the connection information transmitted from the result transmission unit.

In an exemplary embodiment, the information associated with the medium information includes information indicating whether or not the medium information is to be used for the data communication processing. The matching processing unit sets information processing apparatuses which use the medium information and perform the data communication processing, based on the information transmitted from each of the plurality of information processing apparatuses.

In an exemplary embodiment, each information processing apparatus further includes a processor which performs prescribed information processing by using the medium information and an updating unit which updates the medium information by establishing contactless communication based on a result of processing by the processor. The communication processing unit performs the data communication processing for transmitting and receiving data by using the updated medium information, based on the connection information transmitted from the result transmission unit when the medium information is updated.

In an exemplary embodiment, the communication processing unit performs the data communication processing for transmitting and receiving data by using a character which is based on the medium information and cannot accept an operation by a user.

In an exemplary embodiment, the communication processing unit performs the data communication processing for transmitting and receiving data by using information on a player character which can accept an operation by a user and information on a support character controlled by a computer based on the medium information.

In an exemplary embodiment, the information associated with the medium information includes partial data forming the medium information. The matching processing unit sets information processing apparatuses which satisfy a prescribed condition for performing the data communication processing based on the partial data included in the information transmitted from each of the plurality of information processing apparatuses.

In an exemplary embodiment, each information processing apparatus further includes an updating unit for updating the medium information based on a result of the data communication processing.

In an exemplary embodiment, the matching processing unit includes a list generation unit for generating a list of other information processing apparatuses which satisfy the prescribed condition for performing the data communication processing based on the information transmitted from each of the plurality of information processing apparatuses and transmitting the list to the information processing apparatus.

In an exemplary embodiment, each information processing apparatus further includes a selection unit for accepting selection of an information processing apparatus which performs the data communication processing, from the list of other information processing apparatuses transmitted from the list generation unit. The matching processing unit further includes a setting unit for setting information processing apparatuses which perform the data communication processing based on a result of selection from the list, which is transmitted from the information processing apparatus

A method of controlling an information processing system including a server and a plurality of information processing apparatuses provided to be able to communicate with the server and another information processing apparatus through a network according to one aspect includes the steps of each information processing apparatus obtaining medium information from an information storage medium by establishing contactless communication with the information storage medium, the server setting a combination of information processing apparatuses which establish communication connection through the network, of the plurality of information processing apparatuses, and performing data communication processing by using medium information obtained from the information storage medium through the network between information processing apparatuses set by the server, of the plurality of information processing apparatuses.

A server provided to be able to communicate with a plurality of information processing apparatuses through a network, each of which can obtain information from an information storage medium by establishing contactless communication with the information storage medium, according to one aspect includes a matching processing unit for setting information processing apparatuses which satisfy a prescribed condition for performing data communication processing, based on information transmitted from each of the plurality of information processing apparatuses and associated with the information storage medium and a result transmission unit for transmitting connection information necessary for communication connection to the set information processing apparatuses of the plurality of information processing apparatuses.

A non-transitory storage medium encoded with a computer readable program executed by a computer of a server provided to be able to communicate with a plurality of information processing apparatuses through a network, each of which can obtain information from an information storage medium by establishing contactless communication with the information storage medium, according to one aspect, the program causing the computer of the server to function as a matching processing unit for setting information processing apparatuses which satisfy a prescribed condition for performing data communication processing, based on information transmitted from each of the plurality of information processing apparatuses and associated with the information storage medium and a result transmission unit for transmitting connection information necessary for communication connection to the set information processing apparatuses of the plurality of information processing apparatuses.

An information processing apparatus provided to be able to communicate with a server and another information processing apparatus through a network according to one aspect includes a reading unit for reading medium information stored in an information storage medium by establishing contactless communication with the information storage medium, a transmission unit for transmitting information associated with the medium information to the server in accordance with reading by the reading unit, and a communication processing unit for performing, by using the medium information obtained from the information storage medium, processing for data communication with another information processing apparatus set by the server, with which the information processing apparatus communicates and connects through the network.

A non-transitory storage medium encoded with a computer readable program executed by a computer of an information processing apparatus provided to be able to communicate with a server and another information processing apparatus through a network according to one aspect, the program causing the computer of the information processing apparatus to function as a reading unit for reading medium information stored in an information storage medium by establishing contactless communication with the information storage medium, a transmission unit for transmitting information associated with the medium information to the server in accordance with reading by the reading unit, and a communication processing unit for performing, by using the medium information obtained from the information storage medium, processing for data communication with another information processing apparatus set by the server, with which the information processing apparatus communicates and connects through the network.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a diagram illustrating a configuration of an information processing system 1 based on an embodiment.

FIG. 2 is a diagram illustrating a hardware configuration of an information processing apparatus 100 based on the embodiment.

FIG. 3 is a diagram illustrating a hardware configuration of a server 50 based on the embodiment.

FIG. 4 is a schematic diagram showing an RF tag 200 of a figure type used in information processing apparatus 100 based on the embodiment.

FIG. 5 is a diagram illustrating characteristic data stored in RF tag 200 based on the embodiment.

FIG. 6 is a diagram illustrating a first condition selection screen 400 for selecting a form of a match in game processing provided by a game program 122 based on the embodiment.

FIG. 7 is a diagram illustrating a second condition selection screen 500 for selecting a condition for the form of the match in the game processing provided by game program 122 based on the embodiment.

FIG. 8 is a diagram illustrating a screen 600 for accepting registration of a support character in the game processing provided by game program 122 based on the embodiment.

FIG. 9 is a diagram illustrating a screen 700 for accepting selection of a player character in the game processing provided by game program 122 based on the embodiment.

FIG. 10 is a diagram illustrating a game execution confirmation screen in the game processing provided by game program 122 based on the embodiment.

FIG. 11 is a diagram illustrating a screen during play of a tennis game in the game processing provided by game program 122 based on the embodiment.

FIG. 12 is a flowchart illustrating processing for transmitting data from information processing apparatus 100 to server 50 provided by game program 122 based on the embodiment.

FIG. 13 is a diagram illustrating search condition information based on the embodiment.

FIG. 14 is a flowchart showing a procedure in matching processing in server 50 based on the embodiment.

FIG. 15 is a conceptual diagram illustrating the matching processing in server 50 based on the embodiment.

FIG. 16 is a flowchart illustrating data communication processing between information processing apparatus 100 and another information processing apparatus provided by game program 122 based on the embodiment.

FIG. 17 is a flowchart illustrating match type game processing in information processing apparatus 100 provided by game program 122 based on the embodiment.

FIG. 18 is a diagram illustrating search condition information based on a first modification of the embodiment.

FIG. 19 is a flowchart showing a procedure in matching processing in server 50 based on a second modification of the embodiment.

FIG. 20 is a flowchart illustrating data communication processing between information processing apparatus 100 and another information processing apparatus provided by game program 122 based on the second modification of the embodiment.

FIG. 21 is a diagram illustrating a list selection screen 900 based on the second embodiment of the embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

A game program according to the present embodiment is executed by an information processing apparatus representing a computer incorporating a contactless communication function. In the present embodiment, communication under near field radio communication (NFC) specifications will be described by way of example of contactless communication between an information processing apparatus and an RF tag. “Contactless communication” herein refers to a communication scheme in which radio waves (for example, electromagnetic induction) from one apparatus generate electromotive force in the other apparatus by way of example. The other apparatus can operate with generated electromotive force (the other apparatus may or may not have a power supply).

In contactless communication, communication can be established when an information processing apparatus and an RF tag are proximate to each other (typically, a distance therebetween is not greater then ten and several centimeters). In contactless communication, sending of radio waves continues while communication between two communication apparatuses is maintained (while another tag is proximate to a communication apparatus). Though a scheme of communication through radio waves is described by way of example, limitation thereto is not particularly intended. Optical communication or communication via other media may be applicable and a scheme is not limited.

[A. Configuration of Overall System]

[a1. Configuration of Information Processing System]

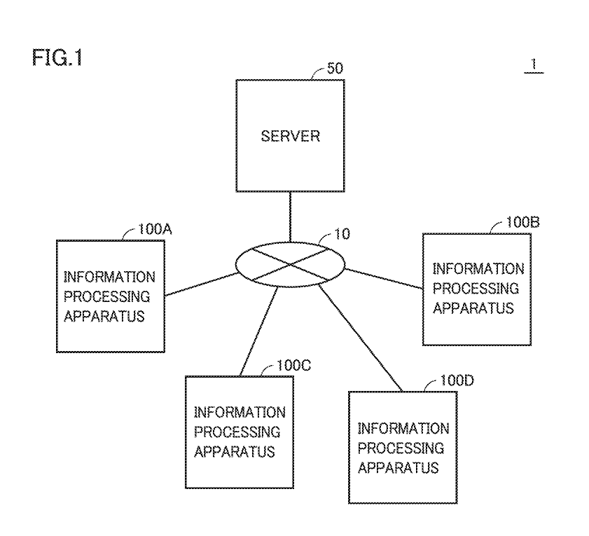

FIG. 1 is a diagram illustrating a configuration of an information processing system 1 based on an embodiment.

As shown in FIG. 1, information processing system 1 includes a plurality of information processing apparatuses 100A to 100D, a network 10, and a server 50.

A plurality of information processing apparatuses 100A to 100D (also collectively referred to as an information processing apparatus 100) and server 50 are connected to be able to communicate with one another through network 10.

Server 50 sets a combination of information processing apparatuses which establish communication connection, of the plurality of information processing apparatuses 100A to 100D. At least two information processing apparatuses among the plurality of information processing apparatuses 100A to 100D perform data communication processing by using information obtained from an RF tag, in accordance with a setting instruction from server 50.

[a2. Hardware Configuration of Information Processing Apparatus]

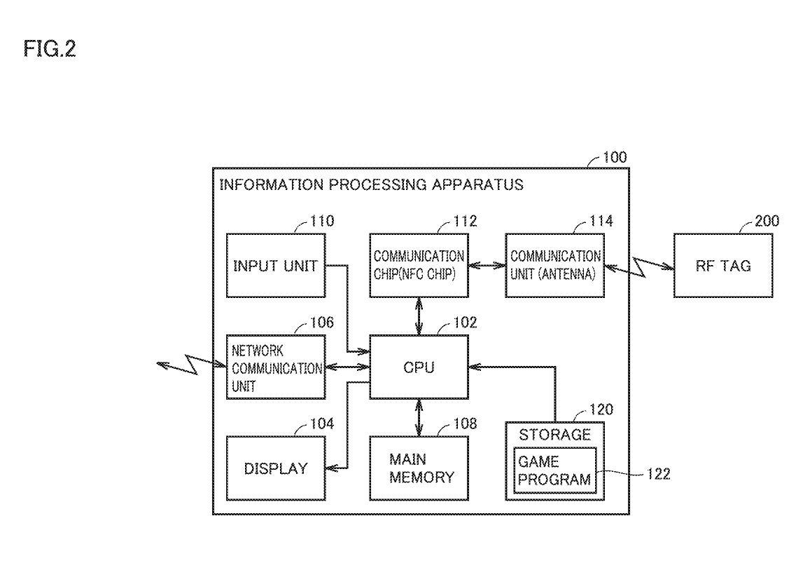

FIG. 2 is a diagram illustrating a hardware configuration of information processing apparatus 100 based on the embodiment. A configuration in which an information processing apparatus according to the present embodiment is mounted as a game device will be described by way of example.

As shown in FIG. 2, information processing apparatus 100 is any computer incorporating a contactless communication function for exchanging data with an RF tag 200 representing one example of an information storage medium. Information processing apparatus 100 may be, for example, a portable (also referred to as mobile) device such as a portable game device, a portable telephone, or a smartphone, a stationary device such as a personal computer or a home game console, or a large apparatus such as an arcade game machine. For example, information processing apparatus 100 may be a portable device having an NFC reader and writer function.

RF tag 200 is any device which can establish contactless communication with information processing apparatus 100. In the present embodiment, RF tag 200 is an information storage medium having a function as an NFC tag. RF tag 200 is a radio frequency identification (RFID) including a circuit which can read from and write into the storage unit, and has a circuit (an IC chip) establishing contactless communication and a storage unit for storing data (such as a memory). RF tag 200 may be a device having only a function to store data (an RF tag), or may be, for example, an information processing apparatus (a portable device) having an NFC card emulation function.

Overview of a hardware configuration of information processing apparatus 100 will be described below. As shown in FIG. 1, information processing apparatus 100 has a communication unit 114. Communication unit 114 is implemented by an antenna used for contactless communication. Information processing apparatus 100 has a communication chip 112. Communication chip 112 generates data (radio waves/signals) to be sent from communication unit 114 in response to an instruction from a central processor (CPU) 102 which will be described later. Generated data is sent from communication unit 114. Communication chip 112 is implemented, for example, by an NFC chip. As CPU 102 executes a game program 122, communication unit 114 and communication chip 112 function as the communication unit which exchanges data with an information storage medium by establishing contactless communication with the information storage medium.

Information processing apparatus 100 has CPU 102 and a main memory 108. CPU 102 is an information processor for performing various types of information processing performed in information processing apparatus 100. CPU 102 performs various types of information processing by interacting with main memory 108.

Information processing apparatus 100 has a storage 120. Storage 120 stores various programs (which may include an operating system and a communication program in addition to game program 122) executed in information processing apparatus 100. Storage 120 is implemented by any storage device (a storage medium) which can be accessed by CPU 102. Storage 120 may be implemented by a storage contained in information processing apparatus 100 such as a hard disk or a memory, a storage medium attachable to or removable from information processing apparatus 100 such as an optical disk or a cartridge, or both of the storage and the storage medium. In such a case, a game system representing one example of an information processing system including information processing apparatus 100 and any storage medium may be implemented.

A communication program stored in storage 120 includes computer readable instructions for implementing data communication with RF tag 200. For example, the communication program is firmware for operating communication chip 112 and may be prepared in advance in information processing apparatus 100 as a library. The communication program has communication chip 112 perform an operation for communication in response to a command from an application. When a plurality of application programs are executable in information processing apparatus 100, the communication program may be used commonly among applications.

Game program 122 includes computer readable instructions for implementing game processing as will be described later by using data read from RF tag 200. A program carrying out data communication with server 50 and a program carrying out data communication with another information processing apparatus are also included as a part of game processing.

The communication program and game program 122 may be mounted integrally as an information processing program or mounted separately from each other.

Information processing apparatus 100 has an input unit 110 implemented as a button or a touch panel and accepting an instruction from a user. Information processing apparatus 100 has a display 104 for displaying an image generated through information processing.

Information processing apparatus 100 has a network communication unit 106. Network communication unit 106 is connected to network 10, and performs processing for data communication with an external apparatus (for example, server 50 or another information processing apparatus 100).

Information processing apparatus 100 may be implemented by a plurality of apparatuses. For example, information processing apparatus 100 may be configured in such a manner that an apparatus having communication unit 114 and communication chip 112 is removably connected to an apparatus having CPU 102 and main memory 108. Information processing apparatus 100 may be implemented by a main body apparatus having CPU 102 and an apparatus having input unit 110 and/or display 104 which are separate from each other. For example, in another embodiment, information processing apparatus 100 may be implemented by a main body apparatus and a terminal apparatus having input unit 110 and display 104, or by a main body apparatus and an operation apparatus having input unit 110. Information processing apparatus 100 may employ a television as a display apparatus, without including display 104.

In another embodiment, at least a part of information processing performed in information processing apparatus 100 may be performed as distributed among a plurality of apparatuses capable of communicating over network 10 (a wide area network and/or a local network).

[a3. Hardware Configuration of Server]

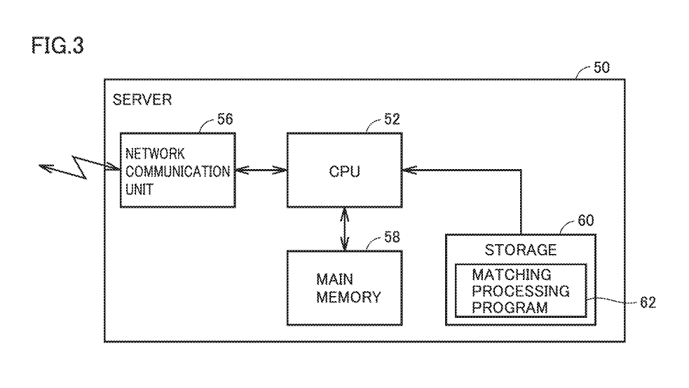

FIG. 3 is a diagram illustrating a hardware configuration of server 50 based on the embodiment.

Server 50 sets a combination of information processing apparatuses which establish communication connection, of the plurality of information processing apparatuses 100, and transmits a result of processing to information processing apparatus 100.

As shown in FIG. 3, server 50 has a CPU 52 and a main memory 58. CPU 52 is an information processor for performing various types of information processing performed in server 50. CPU 52 performs various types of information processing by interacting with main memory 58.

Server 50 has a storage 60. Storage 60 stores various programs (which may include an operating system and a communication program in addition to a matching processing program 62 for performing matching processing which will be described later) executed in server 50. Storage 60 is implemented by any storage device (a storage medium) which can be accessed by CPU 52. Storage 60 may be implemented by a storage contained in server 50 such as a hard disk or a memory, a storage medium attachable to or removable from server 50 such as an optical disk or a cartridge, or both of the storage and the storage medium.

Server 50 has a network communication unit 56. Network communication unit 56 is connected to network 10 and performs processing for data communication with an external apparatus (for example, another information processing apparatus 100).

Server 50 may be implemented by a plurality of apparatuses. For example, server 50 may be configured in such a manner that an apparatus having network communication unit 56 is removably connected to an apparatus having CPU 52 and main memory 58.

[B. Overview of Game Processing]

Overview of game processing provided as game program 122 according to the present embodiment is executed will now be described. Game program 122 according to the present embodiment provides a kind of a match type game in which a plurality of players can participate. The plurality of players may be constituted of one real player and a virtual player provided on a computer.

More specifically, in a tennis game provided by game program 122, a plurality of players form two teams and play against each other on a tennis court. Singles and doubles are selectably provided as forms of a match, and in the doubles, a player character operated by a user and a support character provided on the computer and not operated by the user form one team. Another player character operated by another user and a support character provided on the computer and not operated by another user form another team. Then, a match type virtual tennis game between the teams is executed. Game processing is performed in such a manner that the game proceeds as characters are operated under tennis rules and a team satisfying a predetermined condition wins the game when the condition is satisfied.

In the game processing according to the present embodiment, RF tag 200 is used to register a character to be operated as a support character forming a team in a game space. Namely, information processing apparatus 100 progresses the game processing by reading data stored in RF tag 200 by establishing contactless communication with RF tag 200 representing one example of the information storage medium. By way of example, the support character is operated not by a user but by a computer. Therefore, the support character is set not to accept an operation by the user.

In the present embodiment, a plurality of types of RF tags 200 are prepared. Namely, a plurality of types of RF tags 200 (information storage media) from which information processing apparatus 100 reads data through contactless communication are present. Any RF tag may be adopted so long as RF tags can be categorized into a plurality of types in any sense. By way of example, in the present embodiment, a figure type RF tag is adopted. A card type, stick type, or pen type RF tag may be adopted.

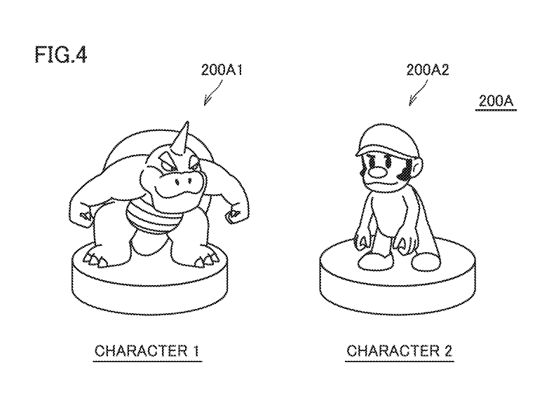

FIG. 4 is a schematic diagram showing RF tag 200 of a figure type used in information processing apparatus 100 based on the embodiment.

As shown in FIG. 4, in the present example, RF tags 200A1 and 200A2 corresponding to a character 1 and a character 2, respectively, are shown.

RF tags 200A1 and 200A2 are associated with characters which appear in a game space.

An RF tag 200A of the figure type is formed in a shape representing an associated character. As will be described later, each of RF tags 200A1 and 200A2 holds identification information representing the associated character and information processing apparatus 100 can specify the associated character by reading the identification information.

In the game processing according to the present embodiment, RF tag 200 of the figure type is used for each player to progress normal game processing. RF tag 200 is used for performing processing as a support character during the game processing.

In the present embodiment, each player uses a character corresponding to RF tag 200A of the figure type as a support character by way of example.

RF tag 200 stores characteristic data representing characteristics of a character, in addition to identification information specifying a character. Characteristic data is also read and made use of in game processing.

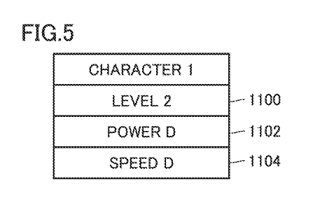

FIG. 5 is a diagram illustrating characteristic data stored in RF tag 200 based on the embodiment.

As shown in FIG. 5, level data 1100, power data 1102, and speed data 1104 are set in correspondence with character 1 and as initial values in advance. Power data 1102 is used for setting of power of a shot in a tennis game. As power data 1102 is higher, a speed of a ball is higher. Speed data 1104 is used in setting of a speed of a character in the tennis game. As speed data 1104 is higher, an operation speed of a character is higher. By way of example, a “level 2” is set as level data 1100, “power D” is set as power data 1102, and a “speed D” is set as speed data 1104. The characteristic data is provided such that it can be updated, and is changed based on winning and defeat in a game, although description thereof will be given later. For example, when a game is won, a level becomes higher and characteristic data becomes higher. When a game is lost, a level lowers and characteristic data lowers. Characteristic data of a character changes based on the level, so that zest of the RF tag can be enhanced.

[C. Screen Representation Example in Game Processing]

A screen representation example and an operation example of game processing provided as a result of execution of game program 122 according to the present embodiment will now be described. A screen representation example is displayed on display 104.

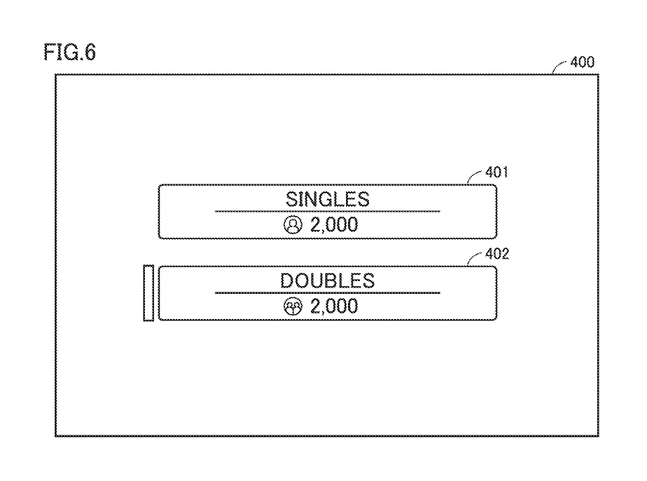

FIG. 6 is a diagram illustrating a first condition selection screen 400 for selecting a form of a match in game processing provided by game program 122 based on the embodiment.

FIG. 6 shows first condition selection screen 400 for selecting “singles” or “doubles” as a form of a match.

A player can select “singles” or “doubles” in first condition selection screen 400 by operating input unit 110.

The “singles” refers to a mode in which a player operates a virtual player character and performs processing for a one-to-one match type tennis game.

The “doubles” refers to a mode in which a player performs processing for a two-to-two match type tennis game, with a virtual player character and a support character specified by RF tag 200 forming one team. By way of example, the player character is operated by the player and the support character is operated by the computer.

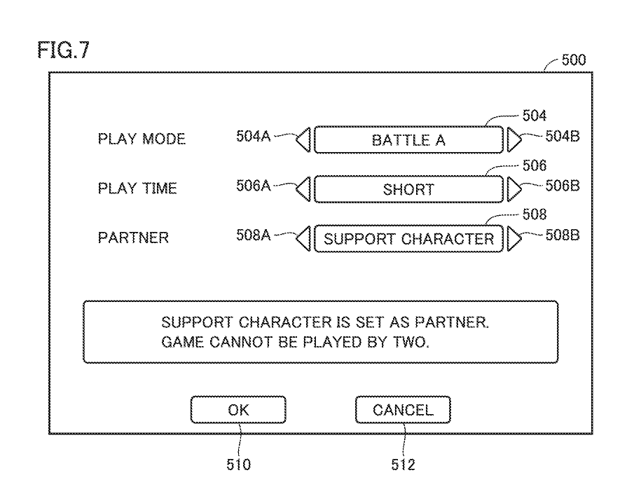

FIG. 7 is a diagram illustrating a second condition selection screen 500 for selecting a condition for the form of the match in the game processing provided by game program 122 based on the embodiment.

FIG. 7 shows second condition selection screen 500 for selecting a “play mode,” a “play time,” and a “partner”.

The “play mode” is for selection as to whether or not to use communication processing through a network for match type game processing. By way of example, the “play mode” includes a “battle A” and a “battle B.” The “battle A” refers to a mode in which match type game processing by using the network is performed as the match type game processing. The “battle B” refers to a mode in which match type game processing in a local information processing apparatus is performed without using the network.

By way of example, an item 504 for “battle A” is selected as the “play mode.” Switching to another mode (for example, “battle B”) can be made by selecting an operation button 504A or 504B.

The “play time” is for selection of a duration of game processing. By way of example, the “play time” includes “short” and “normal”. “Short” refers to a mode for game processing in which game processing ends in a short period of time under a rule (for example, only tie breaker being set) different from general rules of a tennis game. “Normal” refers to a mode for game processing in which game processing ends under general rules of a tennis game.

By way of example, an item 506 “short” is selected as the “play time.” Switching to another mode (for example, “normal”) can be made by selecting operation button 506A or 506B.

The “partner” is for selection of a counterpart with which game processing is performed. By way of example, the “partner” includes a “support character” and “another player character.” The “support character” refers to a mode for game processing in which game processing is performed by a player character and a support character specified by RF tag 200 as one team for doubles.

By way of example, an item 508 “support character” is selected as the “partner.” Switching to another mode (for example, “another player character”) can be made by selecting an operation button 508A or 508B.

Since the “support character” is selected as the “partner”, a message “Support character is set as partner. Game cannot be played by two.” is shown.

In second condition selection screen 500, an “OK” button 510 and a “cancel” button 512 are provided, and game processing based on a condition selected in response to selection of “OK” button 510 proceeds.

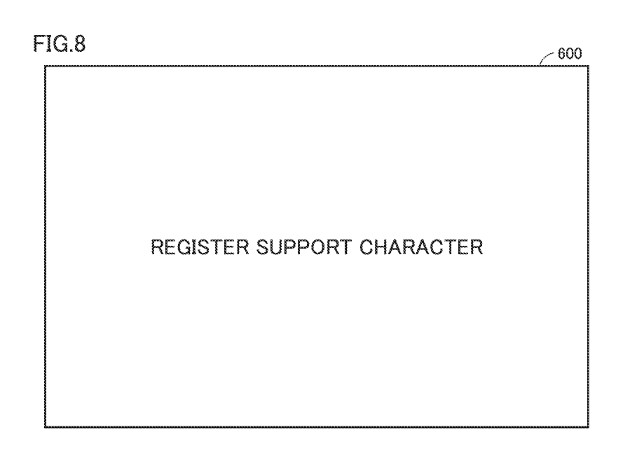

FIG. 8 is a diagram illustrating a screen 600 for accepting registration of a support character in the game processing provided by game program 122 based on the embodiment.

As shown in FIG. 8, registration acceptance screen 600 is displayed when the “support character” is set as the “partner” in second condition selection screen 500.

By bringing RF tag 200 closer to information processing apparatus 100 while registration acceptance screen 600 is displayed, data is communicated between RF tag 200 and communication chip 112. Communication chip 112 obtains medium information stored in RF tag 200 and outputs the obtained medium information to CPU 102. The medium information includes identification information identifying a character. CPU 102 specifies an associated character based on the identification information and registers the specified character as a support character.

In game processing for doubles, the registered support character forms one team together with a user character operated by a user.

When reading from RF tag 200 fails within a prescribed period, processing for displaying registration acceptance screen 600 may end.

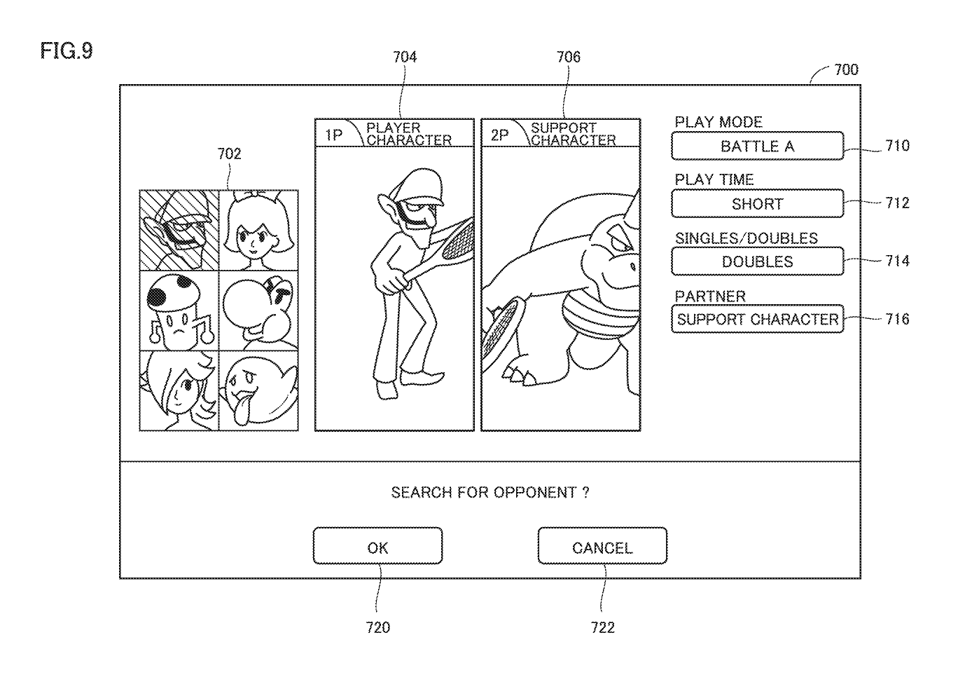

FIG. 9 is a diagram illustrating a screen 700 for accepting selection of a player character in the game processing provided by game program 122 based on the embodiment.

As shown in FIG. 9, in selection acceptance screen 700, a player character list 702, a player character 704 selected from player character list 702, and a registered support character 706 are shown. An item 710 for the “play mode (battle A),” an item 712 for the “play time (short),” an item 714 for “singles/doubles (doubles),” and an item 716 for the “partner (support character)” set in the first and second condition selection screens are shown.

An “OK” button 720 and a “cancel” button 722 are provided together with a message “search for opponent?”

Game processing based on a condition selected in response to selection of “OK” button 720 proceeds.

In the present example, information on the selected condition is transmitted to server 50.

Server 50 receives the information transmitted from information processing apparatus 100, sets a combination of information processing apparatuses which establish communication connection, of the plurality of information processing apparatuses 100, and transmits a result of processing to information processing apparatus 100.

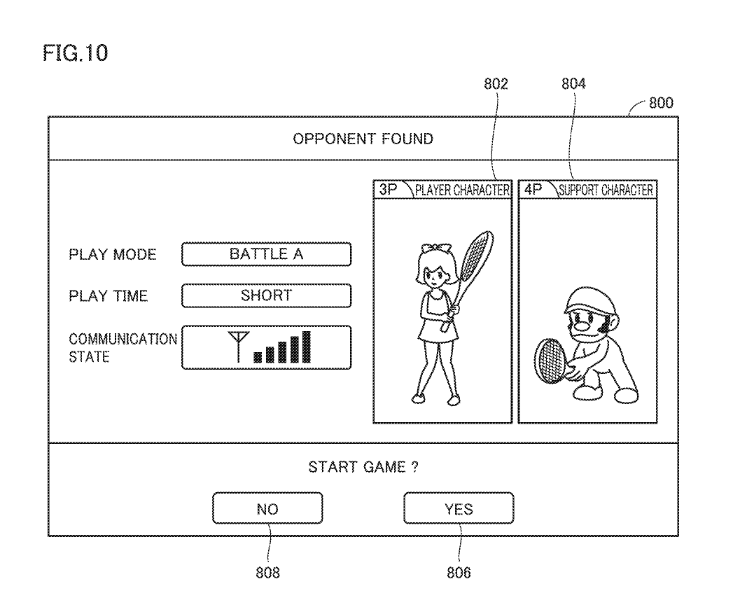

FIG. 10 is a diagram illustrating a game execution confirmation screen in the game processing provided by game program 122 based on the embodiment.

As shown in FIG. 10, in an execution confirmation screen 800, information on an opponent is shown based on a result of processing transmitted from server 50.

In the present example, in execution confirmation screen 800, a “player character” 802 and a “support character” 804 in another information processing apparatus (for example, information processing apparatus 100B) as an opponent are displayed based on the information transmitted from server 50. The “play mode (battle A),” the “play time (short),” and a “communication state” are shown.

A message “start game?” is also displayed.

A “NO” button 808 and a “YES” button 806 are provided, and game processing for the tennis game is started by selecting and operating “YES” button 806 through input unit 110. When “NO” button 808 is selected and operated through input unit 110, the process ends. Alternatively, transition back to a preceding screen may be made.

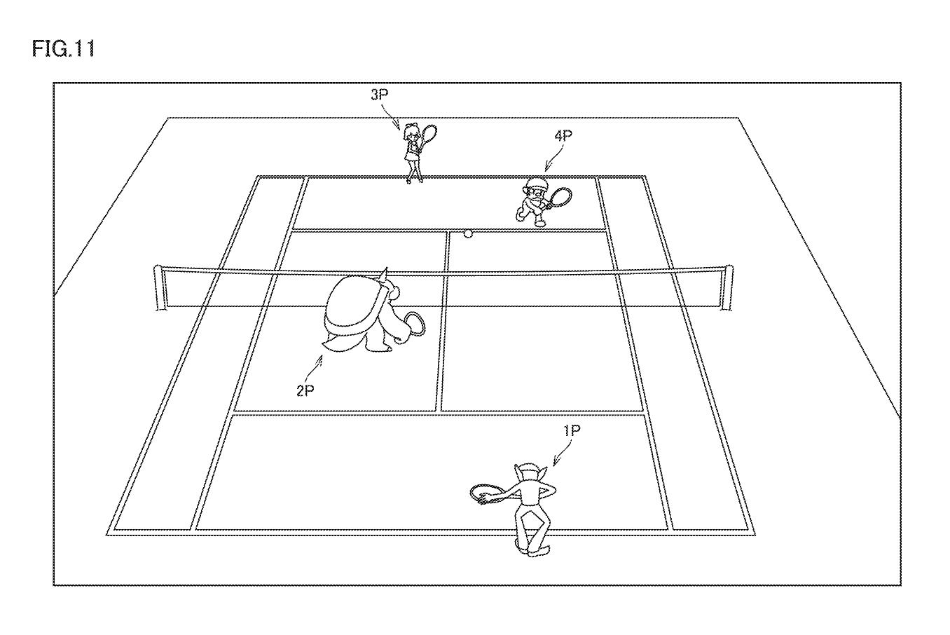

FIG. 11 is a diagram illustrating a screen during play of a tennis game in the game processing provided by game program 122 based on the embodiment.

As shown in FIG. 11, a tennis court is provided and a doubles tennis game is executed. Specifically, a player character 1P and a support character 2P form one team. A player character 3P and a support character 4P form one team.

Player characters 1P and 3P are characters operated by users and support characters 2P and 4P are characters operated by computers.

By way of example, a user of information processing apparatus 100A operates player character 1P. The computer of information processing apparatus 100A operates player character 2P.

A user of information processing apparatus 100B operates player character 3P. The computer of information processing apparatus 100B operates player character 4P.

Game processing data based on operations by the user and the computer of information processing apparatus 100A is transmitted to information processing apparatus 100B through the network.

Game processing data based on operations by the user and the computer of information processing apparatus 100B is transmitted to information processing apparatus 100A through the network.

By transmitting and receiving the game processing data between information processing apparatuses 100A and 100B through network 10, real-time match type game processing can be performed.

Thus, data communication processing by using RF tag 200 can be performed even between remote locations by making use of network 10, and versatility in use of an RF tag and zest can be enhanced.

[D. Processing Procedure in Game Processing]

A processing procedure in game processing provided as a result of execution of game program 122 according to the present embodiment will now be described.

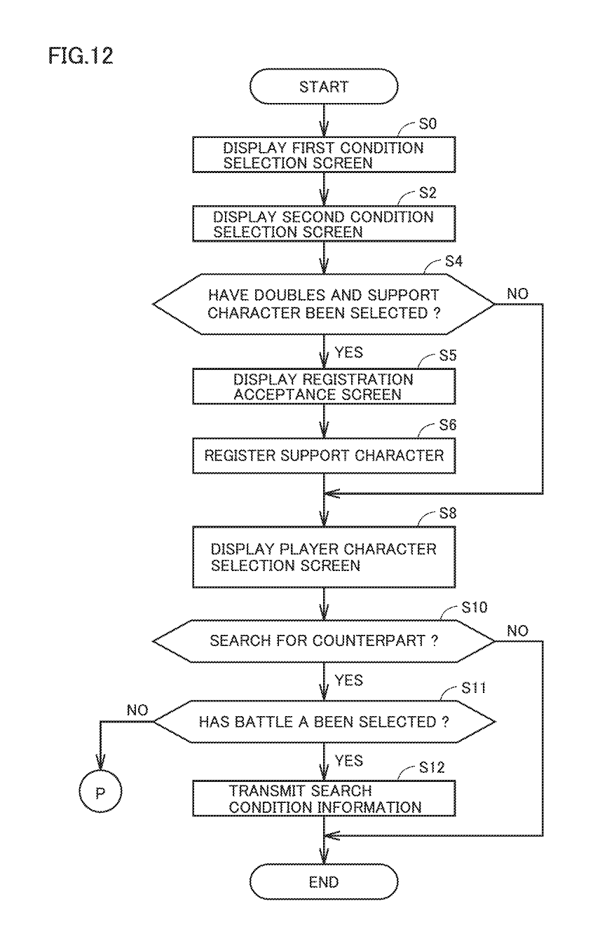

FIG. 12 is a flowchart illustrating processing for transmitting data from information processing apparatus 100 to server 50 provided by game program 122 based on the embodiment.

Each step shown in FIG. 12 is implemented as CPU 102 of information processing apparatus 100 executes game program 122.

Referring to FIG. 12, when game processing is started, CPU 102 has first condition selection screen 400 displayed (step S0).

Specifically, CPU 102 has first condition selection screen 400 described with reference to FIG. 6 displayed. In first condition selection screen 400, the user can select either “singles” or “doubles”. By way of example, “doubles” is selected.

Then, CPU 102 of information processing apparatus 100 has second condition selection screen 500 displayed (step S2). Specifically, CPU 102 has second condition selection screen 500 described with reference to FIG. 7 displayed. The user can select a “play mode,” a “play time,” and a “partner”. By way of example, “battle A,” “short”, and the “support character” are selected.

Then, CPU 102 of information processing apparatus 100 determines whether or not the doubles and the support character have been selected in the condition selection screen (step S4).

When CPU 102 determines in step S4 that the doubles and the support character have been selected in the condition selection screen (YES in step S4), it has registration acceptance screen 600 displayed (step S5). In registration acceptance screen 600, data is communicated between communication chip 112 and RF tag 200.

Then, CPU 102 performs processing for registering the support character (step S6).

By way of example, when registration acceptance screen 600 is displayed, RF tag 200A1 described with reference to FIG. 4 is brought in proximity to information processing apparatus 100A. Character 1 is registered based on identification information in RF tag 200A1.

Then, CPU 102 has screen 700 for accepting selection of a player character displayed (step S8). Specifically, CPU 102 has selection acceptance screen 700 described with reference to FIG. 9 displayed. In selection acceptance screen 700, a user can select a player character operated by the user himself/herself from player character list 702. In the present example, player character 704 is selected. Character 1 is registered as support character 706 based on the identification information in RF tag 200A1. Player character 704 and support character 706 form one team.

Then, CPU 102 determines whether or not an instruction for searching for a counterpart has been accepted (step S10). Specifically, CPU 102 determines whether or not selection of “OK” button 720 in reply to a message “search for opponent?” has been accepted in selection acceptance screen 700.

When CPU 102 determines in step S10 that an instruction for searching for a counterpart has been accepted (YES in step S10), it then determines whether or not “battle A” has been selected in the condition selection screen (step S11).

When CPU 102 determines in step S11 that “battle A” has been selected (YES in step S11), it transmits search condition information to server 50 (step S12). Since “battle A” refers to a mode in which match type game processing using the network is performed as the match type game processing, CPU 102 transmits search condition information for performing processing for searching for an opponent to server 50 through network communication unit 106. Then, the process ends (end).

When CPU 102 determines in step S11 that “battle A” has not been selected (NO in step S11), the process proceeds to processing P since “battle B” has been selected. In this case, since “battle B” refers to a mode in which match type game processing in a local information processing apparatus is performed without using the network, processing for transmitting search condition information to server 50 is not performed.

When CPU 102 determines in step S10 that an instruction for searching for a counterpart is not accepted (NO in step S10), the process ends. For example, when CPU 102 accepts selection of “cancel” button 722 in selection acceptance screen 700, the process ends (end).

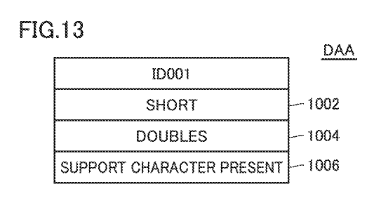

FIG. 13 is a diagram illustrating search condition information based on the embodiment.

Search condition information DAA will be described with reference to FIG. 13.

Search condition information DAA is data for performing processing for searching for an opponent, which has been transmitted from information processing apparatus 100A to server 50 by way of example.

Search condition information DAA here includes play time data 1002, match form data 1004, and support character presence/absence data 1006, which are associated with a specific identification number “001” identifying information processing apparatus 100A.

By way of example, such information as “short” as play time data 1002, “doubles” as match form data 1004, and “support character present” as support character presence/absence data 1006 is set.

Server 50 receives search condition information transmitted from each information processing apparatus 100, sets a combination of information processing apparatuses which establish communication connection, of the plurality of information processing apparatuses 100, and transmits a result of processing to information processing apparatus 100.

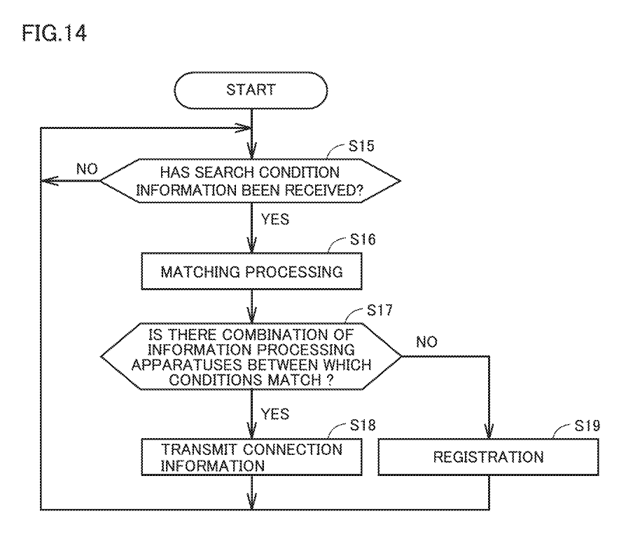

FIG. 14 is a flowchart showing a procedure in matching processing in server 50 based on the embodiment.

Each step shown in FIG. 14 is implemented as CPU 52 of server 50 executes matching processing program 62.

Referring to FIG. 14, when matching processing is started, CPU 52 determines whether or not search condition information has been received (step S15).

In step S15, CPU 52 stands by until search condition information is received, and when the search condition information is received, the process proceeds to a next step.

Then, CPU 52 performs matching processing (step S16). Specifically, by comparing the received search condition information and other already received search condition information with each other, matching processing as to whether or not a prescribed condition is satisfied is performed. Whether or not game processing under the same condition has been set as search condition information is determined as a prescribed condition.

Then, CPU 52 determines whether or not there is a combination of information processing apparatuses between which conditions match (step S17).

When CPU 52 determines that there is a combination of information processing apparatuses between which conditions match (YES in step S17), it transmits connection information (step S18). Specifically, CPU 52 transmits connection information through network communication unit 56 to information processing apparatus 100 which satisfies match in condition. When conditions match, CPU 52 deletes search condition information which has been stored in storage 60 and has satisfied match in condition.

Then, the process returns to step S15.

When CPU 52 determines in step S17 that there is no combination of information processing apparatuses between which conditions match (NO in step S17), it has search condition information registered (step S19). CPU 12 has received search condition information registered (stored) in storage 60. The registered search condition information is maintained until search condition information which satisfies match in condition is received. Then, the process returns to step S15.

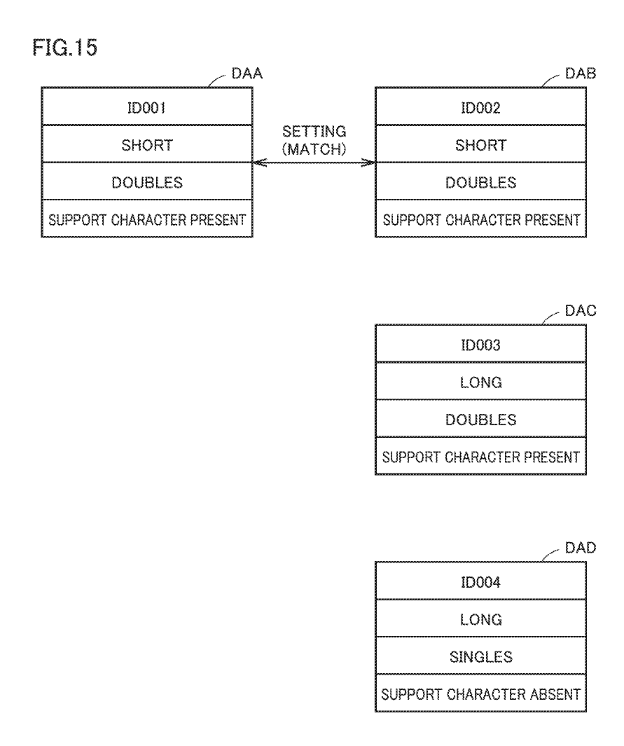

FIG. 15 is a conceptual diagram illustrating matching processing in server 50 based on the embodiment.

As shown in FIG. 15, by way of example, server 50 receives search condition information DAA. Server 50 has received a plurality of pieces of search condition information in advance and has the search condition information registered (stored) in storage 60. In the present example, pieces of search condition information DAB, DAC, and DAD different in condition from one another have been registered.

Search condition information DAB is data associated with a specific identification number “002” identifying information processing apparatus 100B, and such information as “short” as play time data 1002, “doubles” as match form data 1004, and “support character present” as support character presence/absence data 1006 has been set.

Search condition information DAC is data associated with a specific identification number “003” identifying information processing apparatus 100C, and such information as “long” as play time data 1002, “doubles” as match form data 1004, and “support character present” as support character presence/absence data 1006 has been set.

Search condition information DAD is data associated with a specific identification number “004” identifying information processing apparatus 100D, and such information as “long” as play time data 1002, “singles” as match form data 1004, and “support character absent” as support character presence/absence data 1006 has been set.

Server 50 performs matching processing as to whether or not a prescribed condition is satisfied, by comparing received search condition information DAA with pieces of search condition information DAB, DAC, and DAD. In the present example, search condition information DAA and search condition information DAB are determined as satisfying the prescribed condition.

Server 50 transmits connection information as a result of processing in matching processing, to information processing apparatus 100A which has transmitted search condition information DAA and information processing apparatus 100B which has transmitted search condition information DAB. Specifically, server 50 transmits to information processing apparatus 100A, connection information (such as an IP address) for connection through the network, for performing processing for communicating data with information processing apparatus 100B. Server 50 transmits to information processing apparatus 100B, connection information (such as an IP address) for connection through the network for performing processing for communicating data with information processing apparatus 100A.

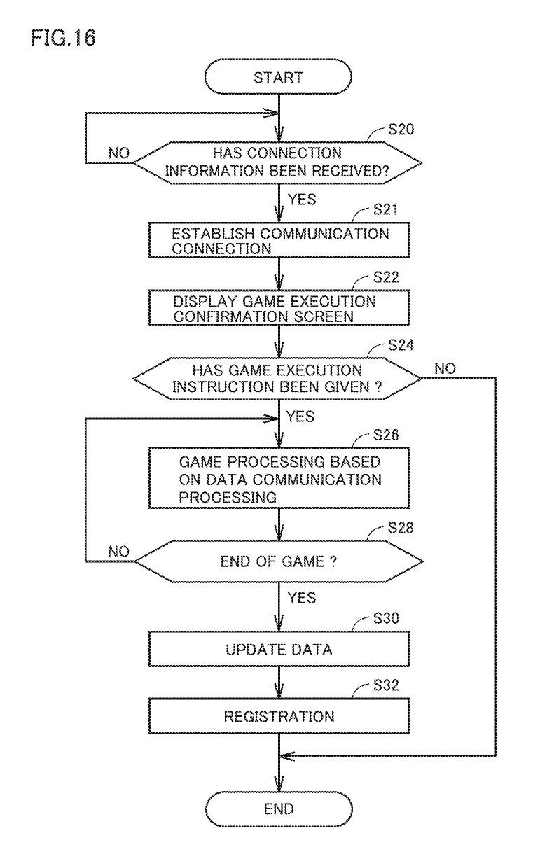

FIG. 16 is a flowchart illustrating data communication processing between information processing apparatus 100 and another information processing apparatus provided by game program 122 based on the embodiment.

Each step shown in FIG. 16 is implemented as CPU 102 of information processing apparatus 100 executes game program 122.

Referring to FIG. 16. CPU 102 determines whether or not connection information has been received (step S20). Specifically, CPU 102 determines whether or not connection information for connection through the network for performing processing for communicating data with another information processing apparatus has been received from server 50 through network communication unit 106.

CPU 102 stands by until connection information is received in step S20, and when it is determined that connection information has been received (YES in step S20), communication connection for performing processing for communicating data through the network is established based on the connection information (step S21). By way of example, information processing apparatus 100A obtains from server 50, connection information (an IP address) for performing processing for communicating data with information processing apparatus 100B.

Then, after communication connection is established, CPU 102 has a game execution confirmation screen displayed (step S22). Specifically, game execution confirmation screen 800 described with reference to FIG. 10 is displayed.

After communication connection is established, information processing apparatus 100A obtains from information processing apparatus 100B, information on a character (a player character and a support character) of information processing apparatus 100B which executes the game.

Then, CPU 102 determines whether or not an instruction to execute the game has been given (step S24). Specifically, when selection of “YES” button 806 has been accepted in execution confirmation screen 800, CPU 102 determines that an instruction to execute the game has been given.

Then, when CPU 102 determines in step S24 that an instruction to execute the game has been given (YES in step S24), it performs game processing based on data communication processing (step S26). Information processing apparatus 100A transmits and receives game processing data to and from information processing apparatus 100B. Specifically, information processing apparatus 100A transmits game processing data based on operations by the user and the computer of information processing apparatus 100A to information processing apparatus 100B through network 10. Information processing apparatus 100B transmits game processing data based on operations by the user and the computer of information processing apparatus 100B to information processing apparatus 100A through network 10. Game processing data includes data on the player character and the medium information.

Information processing apparatus 100A performs real-time match type game processing as described with reference to FIG. 11 based on game processing data resulting from the operations by the user and the computer of information processing apparatus 100A and on game processing data resulting from the operations by the user and the computer of information processing apparatus 100B. This is also the case with information processing apparatus 100B.

Then, CPU 102 determines whether or not the game has ended (step S28). CPU 102 determines whether or not a predetermined condition has been satisfied and determines whether or not the game has ended. CPU 102 determines that a team which has satisfied the condition won. CPU 102 determines that a team which has failed to satisfy the condition was defeated.

When it is determined in step S28 that the game has ended, data is updated (step S30). When CPU 102 determines that the game has ended, it performs processing for updating data based on a result of the game. Specifically, when the game was won, processing for updating characteristic data for raising a parameter is performed. When the game was lost, processing for updating characteristic data for lowering a parameter is performed. In the present example, processing for updating data of a parameter of a support character is performed.

CPU 102 has updated data registered (step S32). In the present example, RF tag 200 is used to update characteristic data of a character registered in RF tag 200. Information processing apparatus 100 performs processing for writing updated characteristic data into RF tag 200 by establishing contactless communication with RF tag 200 representing one example of an information storage medium.

Then, the process ends (end).

When CPU 102 determines that the game has not ended (NO in step S28), the process returns to step S26 and game processing based on data communication processing is continued.

When CPU 102 determines in step S24 that an instruction to execute the game has not been given (NO in step S24), the process ends (end). Specifically, when the user selects “NO” button 808 in execution confirmation screen 800, it is determined that an instruction to execute the game has not been given and the process ends.

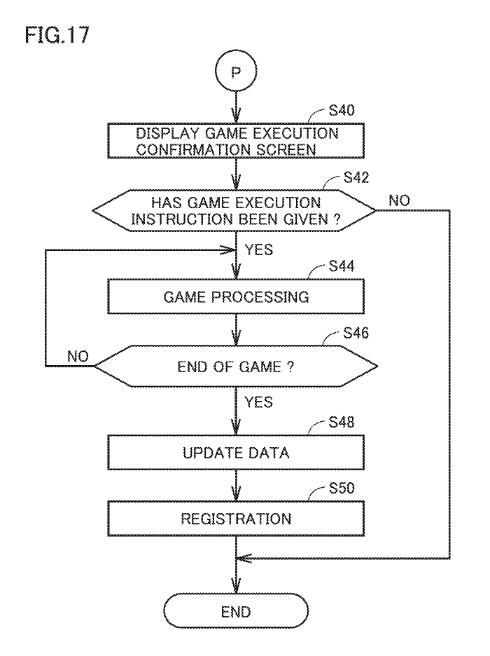

FIG. 17 is a flowchart illustrating match type game processing in information processing apparatus 100 provided by game program 122 based on the embodiment.

Each step shown in FIG. 17 is implemented as CPU 102 of information processing apparatus 100 executes game program 122.

Referring to FIG. 17, CPU 102 has a game execution confirmation screen displayed (step S40). Specifically, a game execution confirmation screen similar to game execution confirmation screen 800 described with reference to FIG. 10 is displayed. In this case, since “battle B” has been set as the play mode, an opponent is not a player character operated by a user of another information processing apparatus 100 or a support character operated by the computer, but a character (for example, a support character) operated by the computer of the same information processing apparatus 100. A plurality of characters operated by the computer of information processing apparatus 100 or one character may be set as opponent(s).

Then, CPU 102 determines whether or not an instruction to execute the game has been given (step 42).

Then, when CPU 102 determines in step S42 that an instruction to execute the game has been given (YES in step S42), it performs game processing (step S44). In this case, information processing apparatus 100A performs local game processing in information processing apparatus 100A itself without communicating data with another information processing apparatus.

Then, CPU 102 determines whether or not the game has ended (step S46). CPU 102 determines whether or not a predetermined condition has been satisfied and determines whether or not the game has ended. CPU 102 determines that a team which satisfies the condition has won. CPU 102 determines that a team which fails to satisfy the condition has been defeated.

When it is determined in step S46 that the game has ended, data is updated (step S48). When CPU 102 determines that the game has ended, it performs processing for updating data based on a result of the game. Specifically, when the game was won, processing for updating characteristic data for raising a parameter is performed. When the game was lost, processing for updating characteristic data for lowering a parameter is performed. In the present example, processing for updating data of a parameter of a support character is performed.

CPU 102 has updated data registered (step S50). In the present example, RF tag 200 is used to update characteristic data of a character registered in RF tag 200. Information processing apparatus 100 performs processing for writing updated characteristic data into RF tag 200 by establishing contactless communication with RF tag 200 representing one example of an information storage medium.

Then, the process ends (end).

When CPU 102 determines that the game has not ended (NO in step S46), the process returns to step S44 and game processing is continued.

When CPU 102 determines in step S42 that an instruction to execute the game has not been given (NO in step S42), the process ends (end). Specifically, when the user selects “NO” button 808 in execution confirmation screen 800, it is determined that an instruction to execute the game has not been given and the process ends.

Therefore, processing for updating data in RF tag 200 based on winning and defeat in a game is performed also in local match type game processing in information processing apparatus 100. Namely, data in RF tag 200 can be updated based on the local match type game processing, without performing processing for a game played against a user of another information processing apparatus through network 10. Therefore, a character high in value for a parameter is grown through processing for updating data in RF tag 200, and the character can be made use of for processing for a game played against a user of another information processing apparatus through network 10. Thus, zest of RF tag 200 can be enhanced.

[E. Modification]

[e1. First Modification]

Though a case that search condition information which satisfies match in all conditions is retrieved as search condition information has been described with reference to FIG. 15 in the embodiment described above, match in condition may be determined only based on match in support character presence/absence data. In that case, a condition high in priority may automatically be set for other conditions.

Alternatively, matching processing using partial data of medium information may be performed.

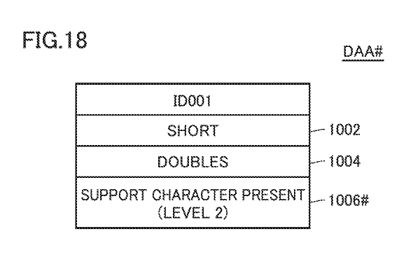

FIG. 18 is a diagram illustrating search condition information based on a first modification of the embodiment.

Search condition information DAA# will be described with reference to FIG. 18.

Search condition information DAA# is data for performing processing for searching for an opponent, which has been transmitted from information processing apparatus 100A to server 50, by way of example.

Search condition information DAA# here includes play time data 1002, match form data 1004, and support character presence/absence data 1006#, which are associated with specific identification number “001” identifying information processing apparatus 100A. In the present example, support character presence/absence data 1006# includes level data as a part of characteristic data, together with information “support character present.”

Server 50 receives search condition information transmitted from each information processing apparatus 100, sets a combination of information processing apparatuses which establish communication connection, of the plurality of information processing apparatuses 100, and transmits a result of processing to information processing apparatus 100. In the present example, in matching processing, whether a support character is present or absent is compared and level data is also compared. When match in level data included in the search condition information is also achieved, it is determined that conditions match. Through the processing, match type game processing between support characters at the same level can be performed. Since support characters at the same level are used, game processing is fair and zest of an RF tag can be enhanced.

Though a case that processing for a match type game played against another information processing apparatus is performed through network 10, with a player character and a support character forming one team in “doubles” representing a form of a match, has been described above, processing for a match type game played between a support character and a player character or a support character of another information processing apparatus may be performed through network 10 in “singles” representing a form of a match.

[e2. Second Modification]

Though a case that matching processing as to whether or not a prescribed condition is satisfied is performed in server 50 and a result of processing is transmitted has been described in the example above, in another embodiment, a list of other information processing apparatuses which satisfy a prescribed condition may be generated and the generated list may be transmitted to information processing apparatus 100.

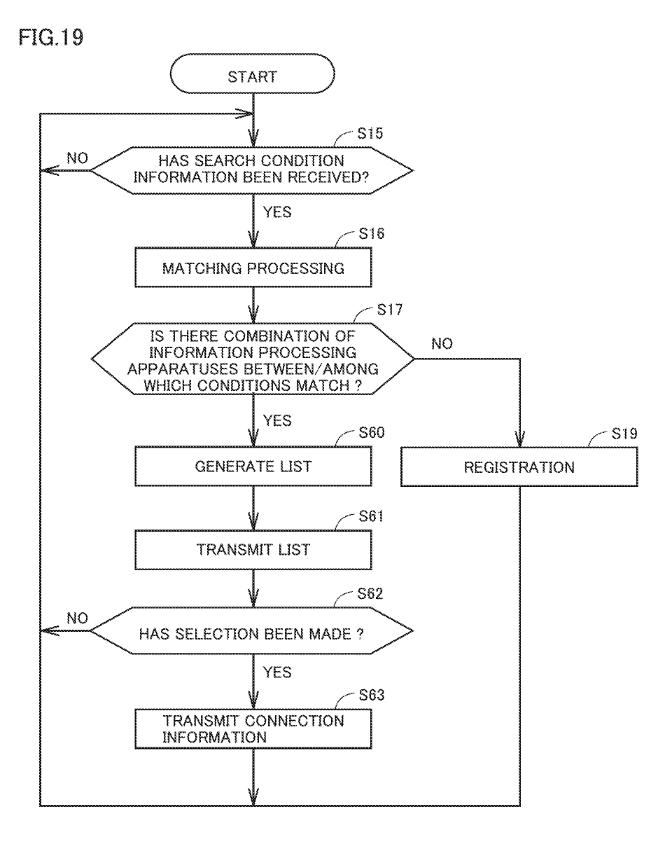

FIG. 19 is a flowchart showing a procedure in matching processing in server 50 based on a second modification of the embodiment.

Each step shown in FIG. 19 is implemented as CPU 52 of server 50 executes matching processing program 62.

Referring to FIG. 19, when matching processing is started, CPU 52 determines whether or not search condition information has been received (step S15).

In step S15, CPU 52 stands by until search condition information is received, and when the search condition information is received, the process proceeds to a next step.

Then, CPU 52 performs matching processing (step S16). Specifically, matching processing as to whether or not a prescribed condition is satisfied is performed, by comparing the received search condition information and other already received search condition information with each other. Whether or not game processing under the same condition has been set as search condition information is determined as a prescribed condition. Regarding a prescribed condition, it may be determined that game processing under the same condition is set when all conditions in search condition information match, or it may be determined that game processing under the same condition is set when some conditions match.

Then, CPU 52 determines whether or not there is a combination of information processing apparatuses between/among which conditions match (step S17).

When CPU 52 determines that there is a combination of information processing apparatuses between/among which conditions match (YES in step S17), it generates a list of other information processing apparatuses between/among which conditions match (step S60).

Then, CPU 52 transmits the generated list to information processing apparatus 100 (step S61).

CPU 52 determines whether or not an instruction for selection from the transmitted list has been given from information processing apparatus 100 (step S62).

When CPU 52 determines in step S62 that an instruction for selection from the list has been given from information processing apparatus 100 (YES in step S62), it transmits connection information to information processing apparatuses between which selected counterparts have matched (step S63). Specifically, CPU 52 transmits connection information through network communication unit 56 to information processing apparatuses 100 between which selected counterparts have matched. When selected counterparts have matched, CPU 52 deletes search condition information which has been stored in storage 60 and has satisfied match in selected counterpart.

Then, the process returns to step S15.

When CPU 52 determines in step S17 that there is no combination of information processing apparatuses between/among which conditions match (NO in step S17), it has search condition information registered (step S19). CPU 12 has the received search condition information registered (stored) in storage 60. The registered search condition information is maintained until search condition information which satisfies match in condition is received. Then, the process returns to step S15.

When CPU 52 determines in step S62 that an instruction for selection from the list has not been given from information processing apparatus 100 (NO in step S62), the process returns to step S15.

A list may be generated and displayed also when conditions for a plurality of pieces of search condition information have not matched but a condition for one piece of search condition information has matched as a result of matching processing by server 50. Alternatively, when a condition only for one piece of search condition information has matched, a list may be generated and connection information may be transmitted to information processing apparatus 100 as described above, without transmitting the list to information processing apparatus 100.

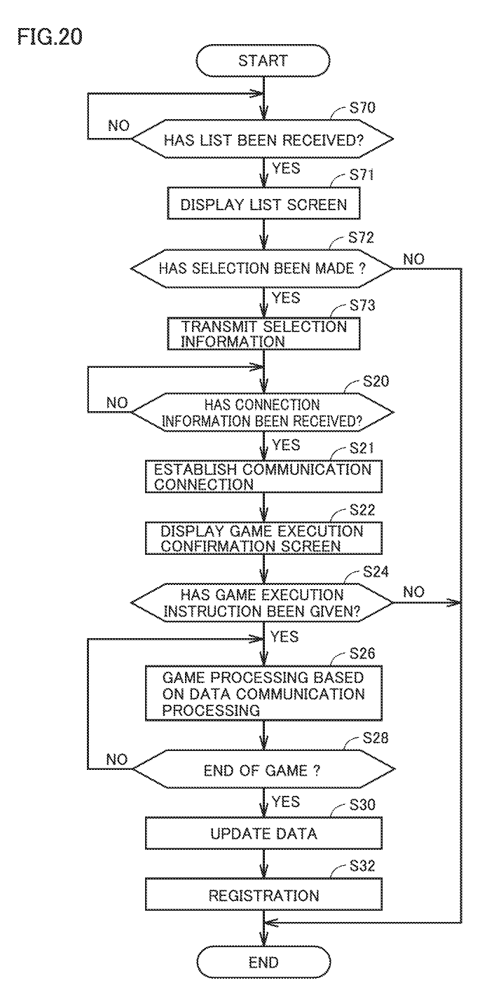

FIG. 20 is a flowchart illustrating data communication processing between information processing apparatus 100 and another information processing apparatus provided by game program 122 based on the second modification of the embodiment.

Each step shown in FIG. 20 is implemented as CPU 102 of information processing apparatus 100 executes game program 122.

Referring to FIG. 20, CPU 102 determines whether or not a list has been received (step S70). The CPU stands by in a state in step S70 until a list is received.

Specifically, CPU 102 determines whether or not a list of other information processing apparatuses which satisfy match in condition has been received from server 50 through network communication unit 106 (step S70).

When CPU 102 determines in step S70 that a list has been received (YES in step S70), it has the list displayed (step S71). Specifically, CPU 102 has display 104 display a list selection screen for selecting another information processing apparatus which satisfy match in condition, based on the received list.

Then, CPU 102 determines whether or not selection has been made in the displayed list selection screen for selecting another information processing apparatus (step S72). Specifically, CPU 102 determines whether or not selection of another information processing apparatus has been accepted in response to an operation instruction from input unit 110.

When CPU 102 determines in step S72 that selection has been made in the list selection screen (YES in step S72), it transmits selection information to server 50 (step S73). Specifically, CPU 102 transmits the selection information to server 50 through network communication unit 106.

CPU 102 determines in step S20 whether or not connection information has been received from server 50. Since the processing and subsequent processing are the same as in the flow described with reference to FIG. 16, detailed description thereof will not be repeated.

When CPU 102 determines in step S72 that selection has not been made in the list selection screen (NO in step S72), the process ends (end).

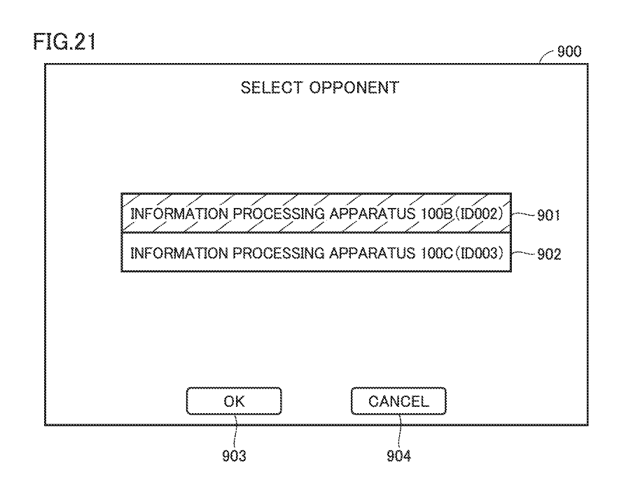

FIG. 21 is a diagram illustrating a list selection screen 900 based on the second modification of the embodiment.

As shown in FIG. 21, together with a message “select opponent,” a list of other information processing apparatuses which satisfy match in condition is shown. By way of example, selection between an item 901 for information processing apparatus 100B corresponding to identification number “002” and an item 902 for information processing apparatus 100C corresponding to identification number “003” can be made. By way of example, item 901 for information processing apparatus 100B corresponding to identification number “002” is selected.

In the present example, in matching processing in server 50 as to whether or not a prescribed condition is satisfied, regarding search condition information, “support character present” being set as support character presence/absence data 1006 can be determined as satisfying a prescribed condition. Specifically, with reference to the example in FIG. 15, search condition information DAA and search condition information DAB and DAC are determined as satisfying the prescribed condition. Then, a list of other information processing apparatuses satisfying match in condition is generated and displayed based on search condition information DAB and DAC.

An “OK” button 903 and a “cancel” button 904 are provided in list selection screen 900.

As a user selects “OK” button 903, information on a selected information processing apparatus is transmitted to server 50. In the present example, when “OK” button 903 is selected, information to the effect that information processing apparatus 100B corresponding to identification number “002” has been selected is transmitted to server 50.

Server 50 receives the selected information from information processing apparatus 100, determines that an instruction for selection from the list has been given as described above, and transmits connection information for access to the selected information processing apparatus.

When “cancel” button 904 is selected, it is determined that selection has not been made, and the process ends.

When search condition information includes level data, level data may also be displayed in displaying a list on list selection screen 900. With such a representation, a user can select an opponent while he/she checks a level of a user of another information processing apparatus so that zest can be enhanced.

With such a scheme, server 50 does not set an opponent but a user can make setting (selection). Therefore, a degree of freedom is high and zest in information processing can be enhanced.

Though a tennis game has been described by way of example of game processing in the present example, limitation to the tennis game is not particularly intended and game processing is similarly applicable also to other games.

An operation entity which performs game processing as described above does not have to be information processing apparatus 100 used by each player. For example, information processing apparatus 100 used by each player may function as an NFC reader and writer and an input and output device and a server apparatus on a network may perform game processing as described above by using the data collected from each information processing apparatus 100.

An application executable by a personal computer may be provided as a program in the present embodiment. Here, the program according to the present embodiment may be incorporated as a partial function (a module) of various applications executed on the personal computer.

[F. Advantages]

According to the present embodiment, as data communication processing is performed between/among information processing apparatuses through a network, processing making use of an RF tag can be performed between/among users at remote locations. A range of application of an RF tag is thus expanded and zest can be enhanced.

While certain example systems, methods, devices, and apparatuses have been described herein, it is to be understood that the appended claims are not to be limited to the systems, methods, devices, and apparatuses disclosed, but on the contrary, are intended to cover various modifications and equivalent arrangements included within the spirit and scope of the appended claims.

What is claimed is:

1. An information processing system, comprising:
a server; and
a plurality of information processing apparatuses provided to be able to communicate with the server and another information processing apparatus through a network,
each information processing apparatus obtaining medium information from an information storage medium by establishing contactless communication with the information storage medium,
the server setting a combination of information processing apparatuses which establish mutual communication connection through the network, of the plurality of information processing apparatuses, and
information processing apparatuses set by the server, of the plurality of information processing apparatuses, performing data communication processing between the information processing apparatuses, by using the medium information obtained from the information storage medium through the network.

2. The information processing system according to claim 1, wherein
each information processing apparatus executes an application program, obtains information from the information storage medium during execution of the application program, and performs the data communication processing by using the information obtained from the information storage medium for use in the application program.

3. The information processing system according to claim 1, wherein
each information processing apparatus includes
a reading unit for reading the medium information stored in the information storage medium by establishing contactless communication with the information storage medium, and
a transmission unit for transmitting information associated with the medium information to the server in accordance with reading by the reading unit,
the server including
a matching processing unit for setting information processing apparatuses which satisfy a prescribed condition for performing the data communication processing, based on information transmitted from each of the plurality of information processing apparatuses, and
a result transmission unit for transmitting connection information necessary for communication connection to the set information processing apparatuses of the plurality of information processing apparatuses, and
each information processing apparatus further includes a communication processing unit for performing the data communication processing for transmitting and receiving data by using the medium information, based on the connection information transmitted from the result transmission unit.

4. The information processing system according to claim 3, wherein
the information associated with the medium information includes information indicating whether the medium information is to be used for the data communication processing, and
the matching processing unit sets information processing apparatuses which use the medium information and perform the data communication processing, based on the information transmitted from each of the plurality of information processing apparatuses.

5. The information processing system according to claim 3, wherein
each information processing apparatus further includes
a processor which performs prescribed information processing by using the medium information, and
an updating unit which updates the medium information by establishing contactless communication, based on a result of processing by the processor, and
the communication processing unit performs the data communication processing for transmitting and receiving data by using the updated medium information, based on the connection information transmitted from the result transmission unit after the medium information is updated.

6. The information processing system according to claim 3, wherein
the communication processing unit performs the data communication processing for transmitting and receiving data by using a character which is based on the medium information and cannot accept an operation by a user.

7. The information processing system according to claim 3, wherein
the communication processing unit performs the data communication processing for transmitting and receiving data by using information on a player character which can accept an operation by a user and information on a support character controlled by a computer based on the medium information.

8. The information processing system according to claim 3, wherein
the information associated with the medium information includes partial data forming the medium information, and
the matching processing unit sets information processing apparatuses which satisfy a prescribed condition for performing the data communication processing based on the partial data included in the information transmitted from each of the plurality of information processing apparatuses.

9. The information processing system according to claim 3, wherein
each information processing apparatus further includes an updating unit for updating the medium information based on a result of the data communication processing.

10. The information processing system according to claim 3, wherein
the matching processing unit includes a list generation unit for generating a list of other information processing apparatuses which satisfy the prescribed condition for performing the data communication processing based on the information transmitted from each of the plurality of information processing apparatuses and transmitting the list to the information processing apparatus,
each information processing apparatus further includes a selection unit for accepting selection of an information processing apparatus which performs the data communication processing, from the list of other information processing apparatuses transmitted from the list generation unit, and
the matching processing unit further includes a setting unit for setting information processing apparatuses which perform the data communication processing based on a result of selection from the list, which is transmitted from the information processing apparatus.

11. A method of controlling an information processing system including a server and a plurality of information processing apparatuses provided to be able to communicate with the server and another information processing apparatus through a network, comprising the steps of:
each information processing apparatus obtaining medium information from an information storage medium by establishing contactless communication with the information storage medium;
the server setting a combination of information processing apparatuses which establish communication connection through the network, of the plurality of information processing apparatuses; and
performing data communication processing using the medium information obtained from the information storage medium through the network, between information processing apparatuses set by the server, of the plurality of information processing apparatuses.

12. A server provided to be able to communicate with a plurality of information processing apparatuses through a network, each of which can obtain information from an information storage medium by establishing contactless communication with the information storage medium, comprising:
a matching processing unit for setting information processing apparatuses which satisfy a prescribed condition for performing data communication processing, based on information transmitted from each of the plurality of information processing apparatuses and associated with the information storage medium; and
a result transmission unit for transmitting connection information necessary for communication connection to the set information processing apparatuses of the plurality of information processing apparatuses.

13. A non-transitory storage medium encoded with a computer readable program executed by a computer of a server provided to be able to communicate with a plurality of information processing apparatuses through a network, each of which can obtain information from an information storage medium by establishing contactless communication with the information storage medium, the program causing the computer of the server to function as:
a matching processing unit for setting information processing apparatuses which satisfy a prescribed condition for performing data communication processing, based on information transmitted from each of the plurality of information processing apparatuses and associated with the information storage medium; and
a result transmission unit for transmitting connection information necessary for communication connection to the set information processing apparatuses of the plurality of information processing apparatuses.

14. An information processing apparatus provided to be able to communicate with a server and another information processing apparatus through a network, comprising:
a reading unit for reading medium information stored in an information storage medium by establishing contactless communication with the information storage medium;
a transmission unit for transmitting information associated with the medium information to the server in accordance with reading by the reading unit; and
a communication processing unit for performing, by using the medium information obtained from the information storage medium, processing for data communication with another information processing apparatus set by the server, with which the information processing apparatus communicates and connects through the network.

15. A non-transitory storage medium encoded with a computer readable program executed by a computer of an information processing apparatus provided to be able to communicate with a server and another information processing apparatus through a network, the program causing the computer of the information processing apparatus to function as:
a reading unit for reading medium information stored in an information storage medium by establishing contactless communication with the information storage medium;
a transmission unit for transmitting information associated with the medium information to the server in accordance with reading by the reading unit; and
a communication processing unit for performing, by using the medium information obtained from the information storage medium, processing for data communication with another information processing apparatus set by the server, with which the information processing apparatus communicates and connects through the network.
